(19) United States
(12) Patent Application Publication
(10) Pub. No.: US 2011/0197819 A1
(43) Pub. Date: Aug. 18, 2011

(54) WILDLIFE GAME FEEDER

(76) Inventor: Myles MONTGOMERY, Cumming, GA (US)

(21) Appl. No.: 13/025,484

(22) Filed: Feb. 11, 2011

Related U.S. Application Data
(60) Provisional application No. 61/304,925, filed on Feb. 16, 2010.

(51) Int. Cl. A01K 5/02; A01K 5/00

(52) U.S. Cl. 119/51.11; 119/57.1; 119/57.92

(57) ABSTRACT

A wildlife feeder according to example forms of the invention includes a storage unit, a removable top cap, an internal funnel, a removable feed dispensing drawer, a removable perforated feed/storage drawer, a locking feed valve, a internal feed dispenser, a programmable timer, external wheels, external handle attachment and ground anchor brackets. In another aspect, the wildlife feeder includes an external surface having the texture and/or appearance of a natural tree bark. In yet another aspect, the wildlife feeder includes a dispensing subassembly, the dispensing subassembly comprising a motor, at least one battery for powering the motor, a paddle wheel driven by the motor, and a programmable timer for controlling operation of the motor.

### CROSS-REFERENCE TO RELATED APPLICATION

This application claims the benefit of U.S. Provisional Patent Application Ser. No. 61/304,925, filed Feb. 16, 2010, the entirety of which is hereby incorporated herein by reference for all purposes.

### TECHNICAL FIELD

The present invention relates generally to a feeder for game, livestock, or other animals.

### BACKGROUND

While various forms of game and animal feeders are known, continued improvement in the field is sought. Therefore, it is to the provision of an improved game and animal feeder that the present invention is primarily directed.

### SUMMARY

In example embodiments, the present invention provides an improved game and animal feeder. In one aspect, the present invention relates to a wildlife feeder including a storage unit, a removable top cap, an internal funnel, a removable feed dispensing drawer, a removable perforated feed/storage drawer, a locking feed valve, a internal feed dispenser, a programmable timer, external wheels, external handle attachment and ground anchor brackets.

In another aspect, the invention relates to a wildlife feeder including an external surface having the texture and appearance of a natural tree bark.

In still another aspect, the invention relates to a wildlife feeder including a dispensing subassembly, the dispensing subassembly having a motor, at least one battery for powering the motor, a paddle wheel driven by the motor, and a programmable timer for controlling operation of the motor.

In still another aspect, the invention relates to a wildlife feeder comprising a storage bin, a feed valve assembly for alternatively allowing and preventing flow of feed particles from the storage bin, a funnel assembly for receiving the feed particles from the storage bin and delivering the feed particles to at least one dispensing mechanism, and a drawer for receiving each said at least one dispensing mechanism

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a perspective view of a wildlife feeder according to an example embodiment of the invention.

FIG. 2 is a perspective view of the typical draw cabinet located at the base portion of the feeder.

FIG. 3 is a perspective view of the upper and lower draw cabinets showing how they will be configured inside the feeder.

FIG. 4 is a perspective view showing lower drawer of the wildlife feeder.

FIG. 5 is a perspective view showing upper drawer of the wildlife feeder.

FIG. 6 is a perspective view showing upper and lower drawer cabinets with locking feed valve assembly.

FIG. 7 is a perspective view of the locking feed valve.

FIG. 8 is a perspective view of the internal funnel with base plate and two support brackets.

FIG. 9 is a perspective view of the bottom portion of the upper and lower drawers showing drain holes for rainwater. Drain holes also serve as mounting holes for internal feed dispenser to be located in the upper cabinet drawer.

FIG. 10 is a perspective view of how the gravity only feed dispenser is attached to the inner base portion of the drawer.

FIG. 11 is a perspective view of how the mechanical paddle wheel feed dispenser is attached to the inner base portion of the drawer.

FIG. 12 is a perspective view of the ground anchor brackets attached to the underside of the lower drawer cabinet.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

In example forms of the invention, the wildlife game feeder is preferably a compact, mobile gravity feeder that is designed to blend in with natural wooded surroundings. In example embodiments, the feeder unit is constructed of molded plastic and can be located at any desired location. In example embodiments, the feeder unit generally comprises an assembly of components including without limitation a top cap, a feed storage bin, an internal funnel, a removable feed dispensing drawer, a removable perforated feed/storage drawer, a locking feed valve, a internal feed dispenser, a programmable timer, external wheels, external handle attachment and/or ground anchor brackets.

In example forms of the invention, the top cap can be fitted with an adhesive wrap which resembles the cut visible growth rings of a tree, and fits securely over the feed storage bin to allow feed to stay dry and to deter unwanted animals from taking the feed. The feed storage bin itself can comprise a section of molded plastic pipe with the exterior having an adhesive wrap, surface texture and/or coloration and finish to match real tree bark. The storage bin optionally includes a partition wall that allows for mixing two different types of feed if desired. This wall runs from the top of the unit to within inches from the bottom opening within the bin. If two different types of feed are used, they will optionally be mixed before entering the paddle wheel dispenser.

In example embodiments, a 6-volt motor or other drive means accompanied by a programmable timer or other control means controls the paddle wheel dispenser. This set up will transport feed to the sloped chute. The chute will drop feed into a feed drawer. The perforated bottom of the feed drawer will hold the feed while allowing rainwater to pass through, in turn keeping feed fresh for a longer period of time and avoiding food contamination. The dispensing subassembly, comprising the programmable timer, battery, motor and paddle wheel, is optionally housed on a panel that can be mounted in the bottom portion of the upper drawer as shown in example form in FIG. 11. The programmable timer can regulate the amount of feed that will enter the feed tray at a set time, keeping food from constantly pouring out and being wasted.

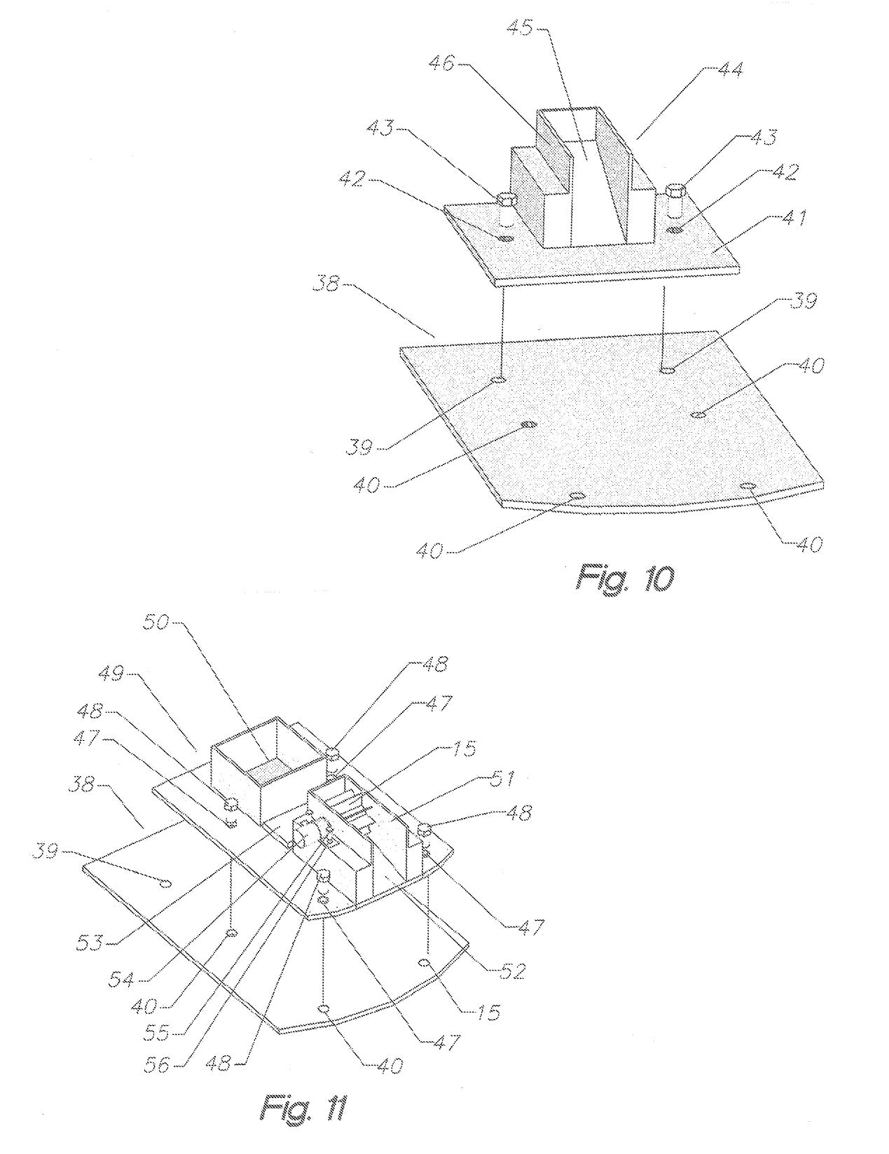

In example embodiments, a non-motorized sloped chute attachment will allow feed to gravity dispense into the perforated feed drawer. The gravity dispensing feed mechanism can be mounted on the bottom portion of the lower perforated drawer as shown in example form in FIG. 10. The lower drawer may then be relocated to the upper drawer cabinet slot. The upper and lower drawer units are optionally removable and interchangeable based on feed dispensing option chosen.

The panel located in the bottom of the unit may be installed by aligning the chute with the notch out section located at the feeder tray, and then pressing upward until the panel rests against the inner rim position guide. Three plastic guides are provided on the lower side of the bottom panel, which when metal plates are inserted, completes installation of the panel. Locking pins are then inserted through the drilled holes located in the metal plates.

In example embodiments, programming of the timer, changing of the battery and/or movement of feeder can be accomplished even when the unit has feed in the storage bin. First, simply move the feed valve assembly to the closed position. The closed position is accomplished by movable valve plate closing off the hole of the feed storage unit. Once the feed valve is in the closed position, drilled hole of the feed valve tab and the drilled hole of the closed tab are aligned, a locking pin is placed through drilled holes to insure feed valve will remain locked. Now the battery and programmable timer can be accessed and/or feeder can be moved to another location allowing feed to remain in the storage bin. To allow feed to dispense from storage bin simply slide the feed valve tab to align with the hole located in the open tab and insert the locking pin to insure feed valve will remain in the open position.

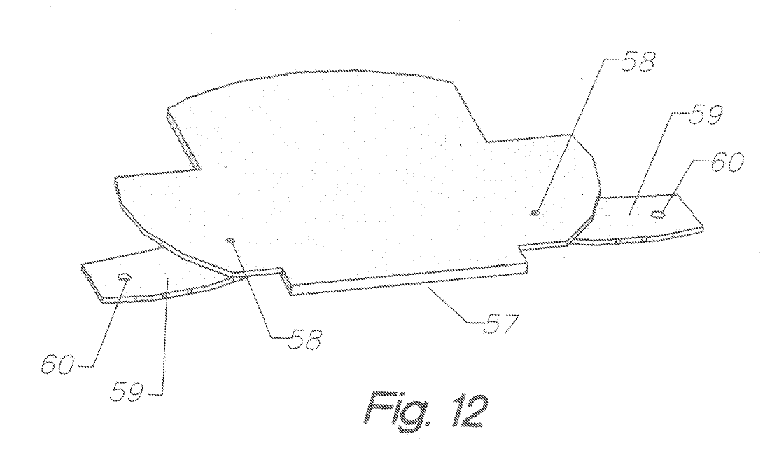

The feeder unit can be set up at any desired location. With reference to FIG. 12, the ground anchor brackets attached to the bottom portion of the feeder can be folded in or out based on status of use of the feeder. The brackets can be folded in for storage and/or when feeder is mobile. Brackets can be folded out, allowing a spike to be driven through the hole located in the bracket, anchoring the unit to the ground. The ground anchor brackets can also be utilized while filling the feeder. One ground anchor bracket folded in the out position will allow the user to place his/her foot on top of bracket, thus keeping the feeder in an upright position. Once the feeder has been filled the top cap can be secured.

In example embodiments, the exterior of the unit will look like actual tree bark by means of attaching an adhesive wrap, painting, screen printing, or other mode of application. Not only does its size and shape make it different from other known products, but also the fact that it has a mechanical dispenser housed inside the unit. This enables owners to feed wildlife at their discretion and know that that their choice of feed will last longer.

Further alternate embodiments within the scope of the invention optionally comprise one or more of the following, in various combination(s) or subcombination(s):
Feeder unit constructed out of a foam material or metal.
Feeder exterior finish can be smooth, textured or have a camouflage print placed on it.
Partition wall for mixing feeds can be removable or omitted altogether.
Means of dispensing feed can be solely gravity-fed, with no mechanical parts required.
Feeder unit can be connected to a tree by means of ratchet straps, can have connected support legs that hold the unit upright or can be hoisted into the air by rope or chain attached to the top portion of the feeder unit and supported from a tree limb.
Feeder cap can have a smooth or jagged sloped top resembling a tree that has snapped by nature.
Feeder cap can be attached to unit by means of latches, button pins or screw on.
Drawer cabinets can be attached by means of latches, button pins or screw on.
Lever action or screw in mechanism can be used to shut or open bottom portion of funnel.
Dispensing unit components, including motor, battery, dispensing plate/wheel and/or programmable timer can be located on the outside of the unit or remotely located.
Wheels can be removable for easy maintenance or storage.
Cameras, video recorders, picture viewers and other media accessories can be built-in or attached to feeder unit.
Other scent, powder and/or liquid dispensers, as well as solid wildlife attractants can be mounted to the outside/inside of feeder unit.
Drawers can be used to transport hunting gear in and out of the field.
Feeder unit can aid in the transporting of retrieved game.
Feeder unit can have a built-in activator button for dispensing feed while in movement. A remote control can also be used to activate feed dispensing motor.
Feeder can be attached to back of All Terrain Vehicle or Pickup Truck by means of a mounting bracket.
Solar panel can be built into feeder unit to recharge batteries or power other accessories.
Top cap can be designed to allow for placement of other wildlife feed or attractants.
Feed dispensing motor could be controlled by means of a photocell timer. Release feed and sunrise and sunset.

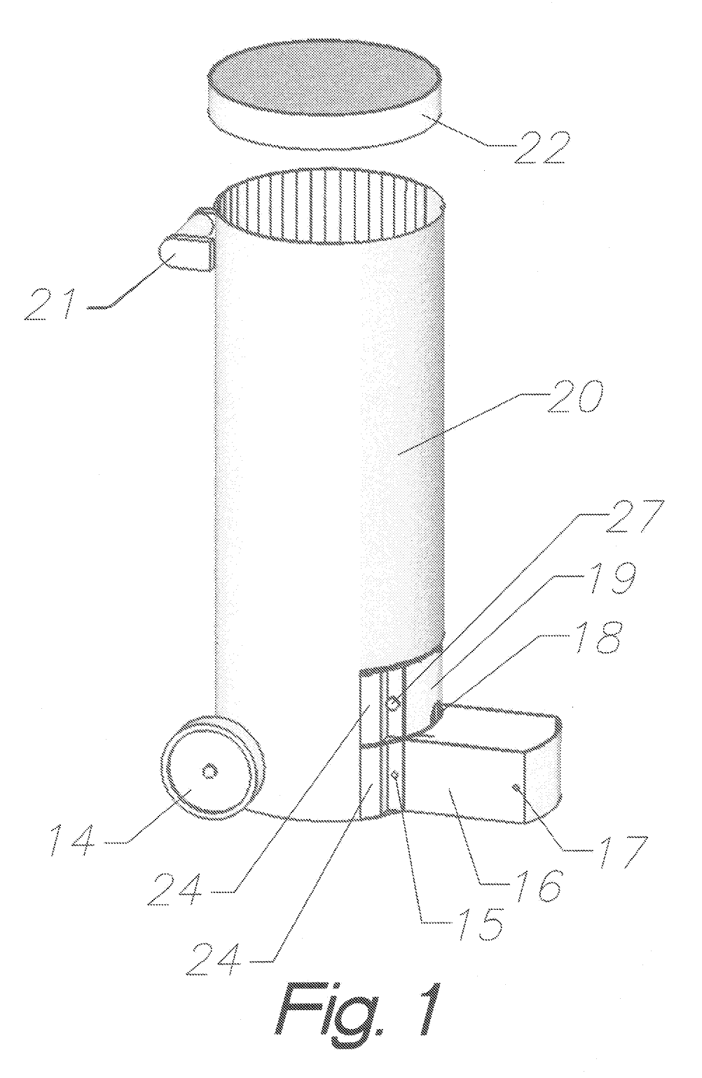

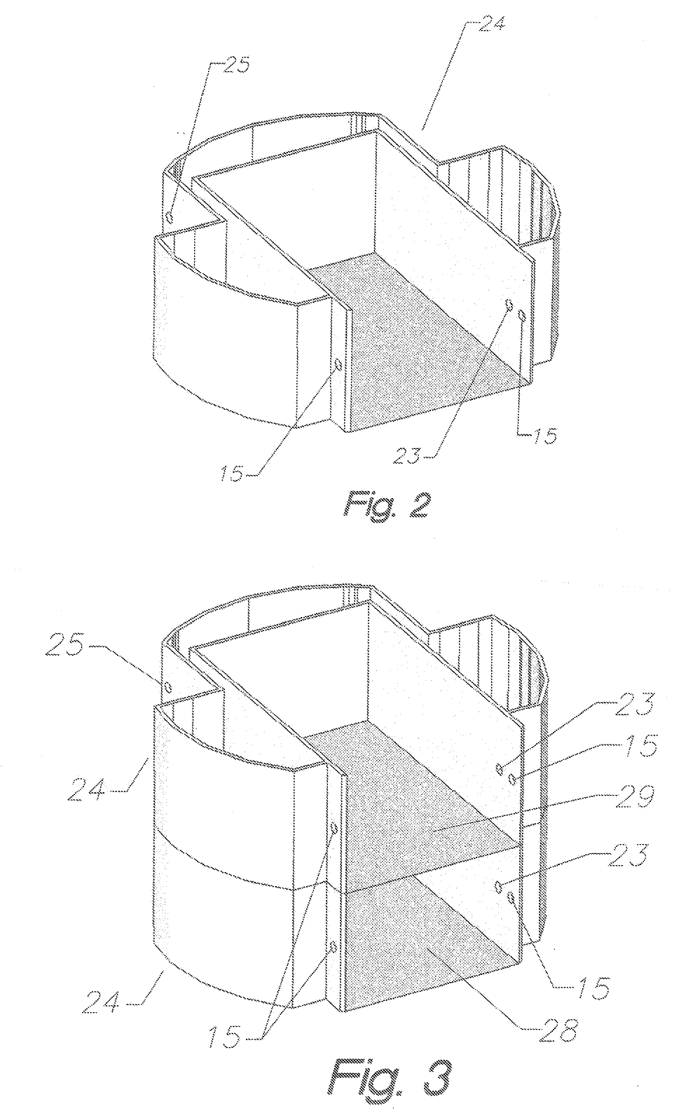

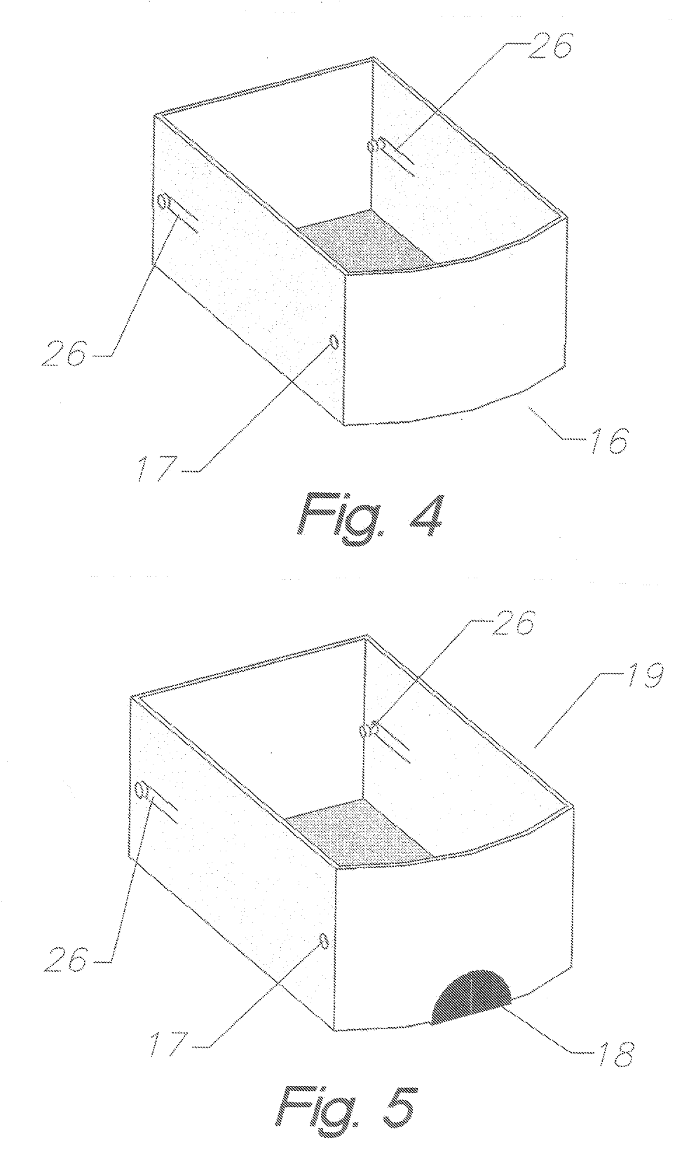

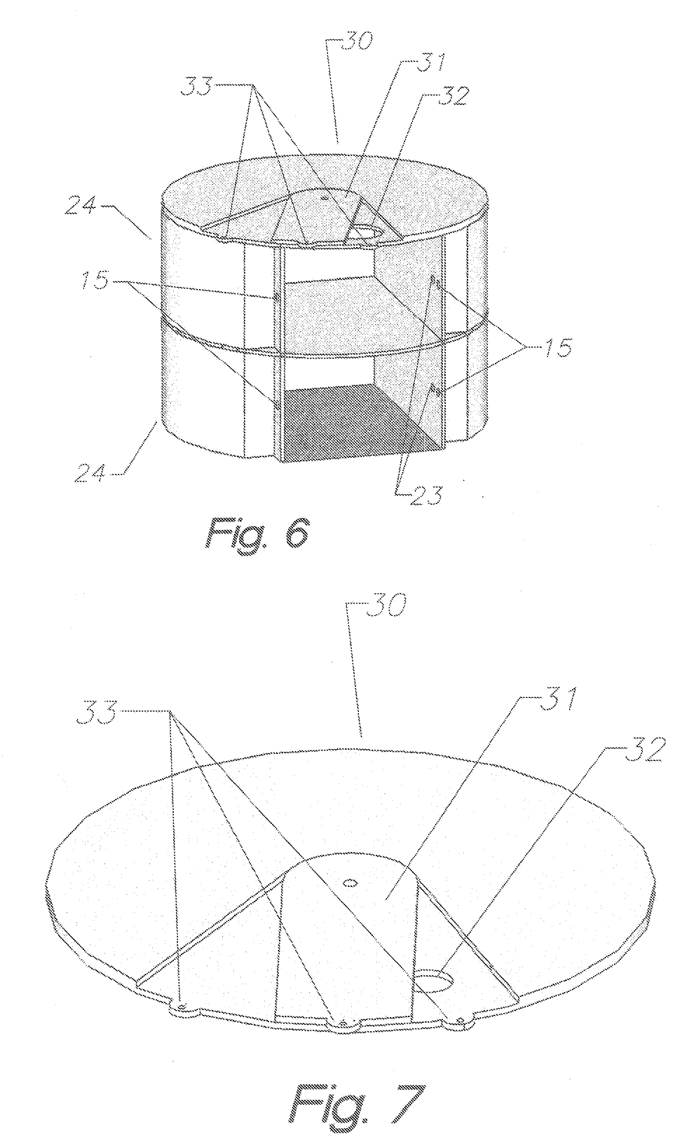

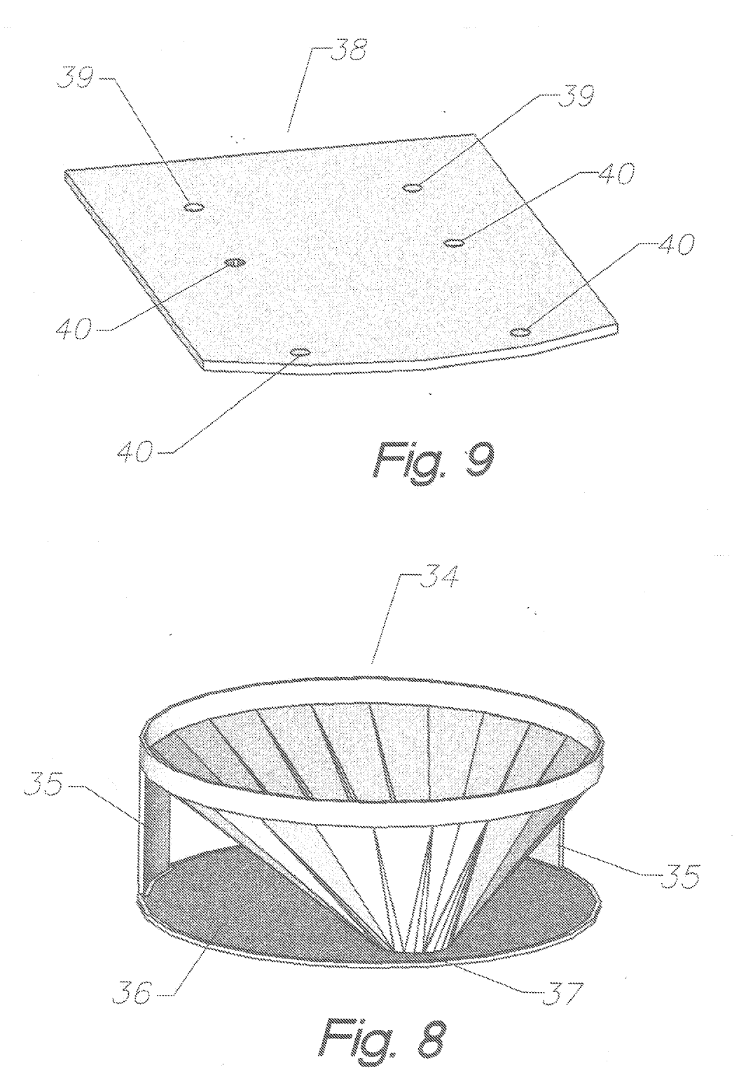

With reference now to the drawing figures, wherein like reference numbers represent corresponding parts throughout the several views, FIGS. 1-12 show an example form of a wildlife game feeder according to the present invention, generally comprising a storage unit, a removable top cap, an internal funnel, a removable feed dispensing drawer, a removable perforated feed/storage drawer, a locking feed valve, a internal feed dispenser, a programmable timer, external wheels, external handle attachment and ground anchor brackets.

Wheels 14 are provided for mobility, and optionally can be removable. The wheel assembly is attached to an axel that will run through drilled holes located in the storage unit and lower cabinet. A drilled hole 15 is provided in the drawer cabinet for inserting a rod and pin for locking the drawer in a closed position. The lower drawer unit 16 may have a perforated bottom and drilled holes for mounting feed dispensing units, and optionally has the same dimensions as upper drawer. A drilled hole 17 in the lower drawer 16 allows for inserting a rod and pin for locking the drawer in a closed position. An opening 18 in the upper drawer allows feed to exit the chute while using the motorized feed dispensing unit. The upper drawer unit 19 preferably has a solid bottom with drilled holes for mounting feed dispensing units, and the same dimensions as the lower drawer.

The storage unit 20, as shown, will slide down over the funnel unit, feed valve assembly, and the upper and lower cabinet assembly. It will preferably be attached to the lower cabinet unit by means of screw or bolt fasteners. The wheel assembly will be attached to an axel that will run through drilled holes located in the storage unit and lower cabinet. The exterior of the storage unit will receive adhesive wrap that resembles tree bark. A handle 21 is preferably attached to the upper exterior of the storage unit, and used to aid in transport of the unit from one place to another. The handle will be attached by means of rivet, screw or bolt fasteners.

The top cap unit 22 can be screwed, latched or fastened to the storage unit or handles. The top cap will keep unwanted animals out of feed and keep feed storage area dry. The top cap can be made to look like a snapped tree or can receive an adhesive wrap that resembles tree growth rings. A drilled hole 23 is preferably provided in the cabinets to catch the drawer latching mechanism, and keeps the drawers from being pulled out of the feeder by animals. Upper and lower drawer cabinets 24 are attached together by means of adhesive, screw, bolt or other manufactured fasteners. A drilled hole 25 in the rear portion of the drawer cabinet is provided to receive the wheel axel.

A latching mechanism 26 catches in the hole of the drawer cabinet to keep the drawer from being pulled all the way out, and can be unlocked by pulling the inner stem towards the center of the drawer. Pressure will then be released on the exterior pin, thus allowing the drawer to be pushed in or removed. The lower drawer will sit in the inside area 28 of the lower drawer cabinet, and the upper drawer will sit in the inside area 29 of the upper drawer cabinet.

A locking feed valve assembly 30 consists of a solid plate with open/closed drilled tabs and a movable valve plate with a drilled tab. Based on tab alignment the valve can be locked in an open or closed position by inserting a locking pin thru drilled tabs. The valve plate is attached to the solid plate by means of rivet, bolt or other fasteners that will allow movement of valve plate. The feed valve assembly will be attached to the drawer cabinet assembly by means of adhesives, screw, bolt or other fasteners. Details of the feed valve plate 31 are shown in FIG. 7. A hole 32 is provided for dispensing of feed. Drilled tabs 33 are used for locking the feed valve in its open or closed position.

The funnel assembly 34 is used to remove all feed from storage unit. Support brackets 35 provide support for the funnel and hold the funnel in place while feed is placed inside the storage unit. The funnel assembly plate 36 is used to hold the funnel and brackets in place. The funnel assembly opening 37 is aligned with the hole in the locking feed valve assembly.

The bottom portion 38 of both the upper and lower drawers may be the same and may provide the hole pattern as shown on FIG. 9 for mounting gravity only or mechanical feed dispensing units. The drawer bottoms will preferably be perforated, but not to the extent of making it structurally weak. Drilled holes 39 are for mounting the gravity only dispensing unit. Drilled holes 40 are for mounting the mechanical paddle wheel dispensing unit. The bottom support plate 41 for the gravity only dispensing unit includes drilled hole 42 for mounting the gravity only dispensing unit, for example by means of one or more fasteners 43.

The gravity only feed dispensing unit 44 is located inside the unit, and includes a sloped chute 45 for gravity feeding. A side panel 46 extends to the bottom portion of the feed valve assembly. The side panel will keep feed from coming over the side of the chute while dispensing and help control the flow of feed.

A drilled hole 47 is provided for mounting the mechanical paddle wheel feed dispensing unit, for example by one or more fasteners 48. The mechanical feed dispensing unit 49 comprises a paddle wheel, a motor 54 to power the paddle wheel, a sloped chute 52, a programmable timer 53 and a battery, and is located inside the unit. Battery tray 50 is optionally provided. The side panel 51 extends to touch to the bottom portion of the feed valve assembly. The side panel will keep feed from coming over the side of the chute while dispensing, and will help control the flow of feed. A fastener 55 is received through the drilled hole 56 to mount the paddle wheel motor to the unit.

The bottom portion 57 of the lower drawer cabinet includes a drilled hole 58 for mounting one or more ground anchor brackets by way of fasteners that allow for the in and out movement of the ground anchor brackets 59. A hole 60 in the ground anchor bracket allows for a spike or other anchoring mechanism to be hammered into the ground to anchor the apparatus in place.

While the invention has been described with reference to preferred and example embodiments, it will be understood by those skilled in the art that a variety of modifications, additions and deletions are within the scope of the invention, as defined by the following claims.

What is claimed is:

1. A wildlife feeder comprising a storage unit, a removable top cap, an internal funnel, a removable feed dispensing drawer, a removable perforated feed/storage drawer, a locking feed valve, a internal feed dispenser, a programmable timer, external wheels, external handle attachment and ground anchor brackets.

2. The wildlife feeder of claim 1, comprising an external surface having the texture and/or appearance of a natural tree bark.

3. The wildlife feeder of claim 1, comprising a dispensing subassembly, the dispensing subassembly comprising a motor, at least one battery for powering the motor, a paddle wheel driven by the motor, and a programmable timer for controlling operation of the motor.

4. A wildlife feeder comprising a storage bin, a feed valve assembly for alternatively allowing and preventing flow of feed particles from the storage bin, a funnel assembly for receiving the feed particles from the storage bin and delivering the feed particles to at least one dispensing mechanism, and a drawer for receiving each said at least one dispensing mechanism.

5. The wildlife feeder of claim 4, wherein the dispensing mechanism is selected from a gravity only dispensing unit and a motor driven dispensing unit.

6. The wildlife feeder of claim 4, wherein the storage bin comprises an external surface having the appearance of at least a portion of a natural tree.

7. The wildlife feeder of claim 4, further comprising at least one transport wheel.

8. The wildlife feeder of claim 4, further comprising a handle.

9. The wildlife feeder of claim 4, further comprising at least one anchor bracket.

10. The wildlife feeder of claim 9, wherein each anchor bracket pivots in and out relative to a base of the storage bin.

11. The wildlife feeder of claim 4, further comprising a top cap for closing the storage bin, the top cap comprising a pattern having the appearance of tree growth rings.

12. A wildlife feeder comprising:
a storage bin for containing a feed;
a cap for removable attachment over the storage bin;
wherein at least a portion of the storage bin and the cap define an exterior having the appearance of at least a portion of a natural tree;
a handle affixed proximal to an upper end of the storage bin;
a pair of transport wheels rotationally mounted at a lower end of the storage bin;
an upper drawer housing for receiving at least a portion of the feed from the storage bin;
a lower drawer housing arranged below the upper drawer housing for receiving at least a portion of the feed from the storage bin;
a feed valve mechanism for controlling the dispensing of the feed from the storage bin; and
at least one dispenser for dispensing feed from the storage bin.

13. The wildlife feeder of claim 12, further comprising a funnel for controlling the output of the feed from the storage bin.

14. The wildlife feeder of claim 12, wherein the at least one dispenser is gravity fed.

15. The wildlife feeder of claim 12, wherein the at least one dispenser is motor driven.
